(19) United States
(12) Patent Application Publication
(10) Pub. No.: US 2003/0154493 A1
(43) Pub. Date: Aug. 14, 2003

(54) Identifying unique broadcasts

(76) Inventors: Jonathan C. Kagle, Bellevue, WA (US); Benjamin A. Ram, Sunnyvale, CA (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/076,791

(22) Filed: Feb. 14, 2002

(51) Int. Cl. H04N 7/173

(52) U.S. Cl. 725/114; 725/115

(57) ABSTRACT

The present invention relates to systems and methods for uniquely identifying programs included in broadcasts. One or more samples are obtained from a program and these samples are compared with corresponding samples of other programs. The samples are obtained from a descriptive stream such as the closed captioning stream of the program. The comparison of the sample(s) includes compensating the sample(s) for timing/framing offsets and also uses fuzzy comparisons to account for minor data differences. After the samples have been compared, a determination is made as to whether the sample(s) substantially match. If the sample(s) substantially match, the program has already been recorded. If the sample(s) do not match, then the program is recorded as it is likely to be unique with respect to other programs stored by the user.

### BACKGROUND OF THE INVENTION

1. The Field of the Invention

The present invention relates to systems and methods for identifying unique broadcasts. The present invention further relates to systems and methods for determining whether a broadcast has already been processed and more particularly to systems and methods for determining whether a broadcast has been recorded, played, or previously rejected.

2. Background and Relevant Art

Today, almost every home has at least one television set. The programming content that is displayed on each television may be received from various sources. Some televisions, for example, are limited to the programming content that is broadcast over the airwaves. More generally, however, televisions receive programming content over systems that provide significantly more programming content to a user at greater quality than what is received over the airwaves. In particular, programming content is often received over satellite and/or cable television systems.

One advantage of receiving programming content over satellite and/or cable television systems is that the user is able to receive a large number of channels. Advances in technology permit more channels to be broadcast over these systems. As the number of channels increases, the user is able to choose from a corresponding increase in programming content.

Another advantage of receiving programming content over satellite and/or cable television systems is that the user is often provided with guide data. The guide data provides the user with information about television programs that are broadcast, but the guide data is most often used for programming content that is currently being broadcast or that will be broadcast in the future. The guide data, for example, provides program titles, program ratings, short summaries of the programs, program duration, and other information about the programming content being broadcast.

Many of the programs shown on television today are series programs or daily shows and on any given day, it is likely that the same program will be shown on different channels. Sometimes, the same program is broadcast multiple times on the same channel. One difficulty faced by the user is determining whether the same episode of the same program is being shown on the same or different channels. For example, one channel may be broadcasting new episodes of a particular program while another channel is broadcasting episodes of the program that originally aired at an earlier date. Alternatively, different channels may both be broadcasting non-original but distinct episodes of a particular television program. From the guide data, however, the user cannot always identify if the same episode is being shown on the same or different channels. In other words, the user cannot determine whether the programs or episodes are unique with respect to each other or with respect to programs or episodes that have already been recorded or viewed by the user.

From a user's perspective, a program may be unique if the user has not viewed the program. A program can also be unique if the user has viewed the program but has not recorded the program. Because guide data is not always complete or does not provide sufficient detail about some programs users cannot determine whether the programs of interest to the user are unique in this sense. This inability to uniquely identify content prevents the user from more effectively using or enjoying the programming content that is received. For example, users may desire to record an entire season of a particular program in order or a user may not want to have duplicative recordings of a program stored on their recording device. The ability to uniquely identify a program, enable the user to determine if the program is already recorded, or determine if the user has already viewed the program and the like would enable a user to efficiently achieve these and other goals.

Unfortunately, the user is often unable to determine whether a program is unique based on the guide data for several reasons. Often, the programming content guide data is simply insufficient. This is especially true for television programs that are broadcast live or that are tape delayed. Insufficient or inaccurate guide data is also typical of talk shows and infomercials. In these cases, the guide data does not permit the user to make an informed decision regarding the uniqueness of these television shows.

Another reason that prevents a user from uniquely identifying a program is that a user may receive guide data from more than one source. This can occur, for example, when a user has both a digital video recorder and a cable box or when the same device receives programming content from multiple sources. Sometimes, the guide data received from one source will conflict with the guide data from another source and it is very difficult to determine which guide data from which source is more correct.

Thus, unique content is difficult to successfully identify or distinguish from other content. The inability to identify unique content hinders the ability of users to use the content that they receive in various manners. For example, if a user decides to record each instance of a particular television program, it is likely that the user will record the same episode multiple times, even though there is no need to record the same episode multiple times. In some situations, the device may be unable to record future programs for lack of recording space. Recording the same program multiple times is thus undesirable. Alternatively, the device may decide to delete some of the programs that are already recorded in order to accommodate future recordings. The inability to identify the uniqueness of a particular program is also evident when a user desires to record, for example, each episode of a series television program.

### SUMMARY OF THE INVENTION

These and other problems are overcome by the present invention which is directed to systems and methods for identifying a broadcast. The present invention is useful because guide data does not always permit the uniqueness of a particular program to be determined. As previously stated, this can potentially result in a variety of problems such as redundant recordings of the same program. The ability to identify a broadcast or a program, however, allows decisions regarding the broadcast, such as whether to record or discard the broadcast, to be more automatic. The present invention uniquely identifies programs or broadcasts such that actions prescribed by the user can be more effectively implemented and executed.

One of the actions frequently taken by users is to record programs that are included in the broadcasts of satellite and cable television systems. To insure that the user does not record a program that is already recorded on the multimedia device or that the user has already viewed, samples are obtained from the broadcast or the video stream. These samples are then compared with samples taken from programs that are already recorded or with samples of programs that the user has previously viewed but not recorded. Samples for some programs can be created before the program is broadcast in some instances. For example, programs are often broadcast at the same time with respect to a particular time zone. The samples can be generated from a program being broadcast in one time zone and stored on a central location. These samples can be accessed from later time zones and examined to determine the uniqueness of the program. This permits, for example, a multimedia device to determine that a program has not been previously viewed or recorded by a user before it is broadcast in that time zone and without referring to the guide data. Often, these samples are stored remotely from the multimedia device and are accessed as needed.

As the comparison between the samples is performed, simple errors are removed or accounted for by performing a fuzzy compare. Other errors such as timing offsets and framing offsets are also compensated before the samples are compared. From these comparisons, a probability that the samples match can be determined. If the samples substantially match, then the program at issue is likely the same as one of the programs that is already stored on the multimedia device or that the user has already viewed. In this case, the program is not recorded. If no match is found, then the program is recorded.

Another aspect of the present invention is the ability to shorten the program samples through compression, hashing, and the like. These shortened segments are smaller, easier to store and easier to compare. However, shortened segments do not typically enable the performance of fuzzy comparisons. Thus, the comparison of shortened segments usually occurs where the loss of data is minimal or lossless.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a block diagram of an exemplary system for implementing the present invention;

FIG. 2 is a flowchart of an exemplary method of the present invention;

FIG. 3 is a block diagram illustrating how samples from one or more programs are compared to determine the uniqueness of a particular program with respect to other programs;

FIG. 4 is a block diagram that illustrates examples for comparing one program with another program; and

FIG. 5 is a block diagram illustrating an exemplary method for uniquely identifying broadcasts.

### DETAILED DESCRIPTION OF THE PREFERRED EMBODIMENTS

As used herein, multimedia devices include, but are not limited to, digital video recorders, satellite receivers, cable boxes, video receivers, special purpose computers, general purpose computers, video cassette recorders, and the like and any combination thereof. A multimedia device also refers to systems that include one or more devices. A satellite receiver connected with a digital video recorder, for example, is within the scope of a multimedia device as used herein.

One of the advantages provided by multimedia devices is the ability to record television programs and other data streams from various sources. A user is typically able to program the multimedia device to record programs even when the user is absent. However, it is possible that the user will record a program that has already been recorded. As previously mentioned, this frequently occurs because the guide data is inadequate and the user, as well as the multimedia device, is unable to determine whether the program being recorded is unique with respect to previously recorded programs. One advantage of the present invention is that it addresses the limitations of using program guide data to determine whether a program is unique and in particular with respect to programs that are already recorded on the multimedia device.

The present invention relates to systems and methods for identifying broadcasts and to determining whether a particular program has already been recorded or viewed. After the uniqueness of a broadcast is determined, the multimedia device can decide whether to record or otherwise process the broadcast. As used herein, “programming content” may include but is not limited to, programs, shows, broadcasts, television programs, video streams (including audio and closed captioning streams), audio streams, data streams, and the like and any combination thereof. Programming content, program, show, broadcast, television program, video stream, and the like, more generally refer to the data received at a multimedia device from various sources that may include, but are not limited to, satellite systems, cable television systems, the Internet, and the like. A multimedia device refers to devices and computers that receive programming content.

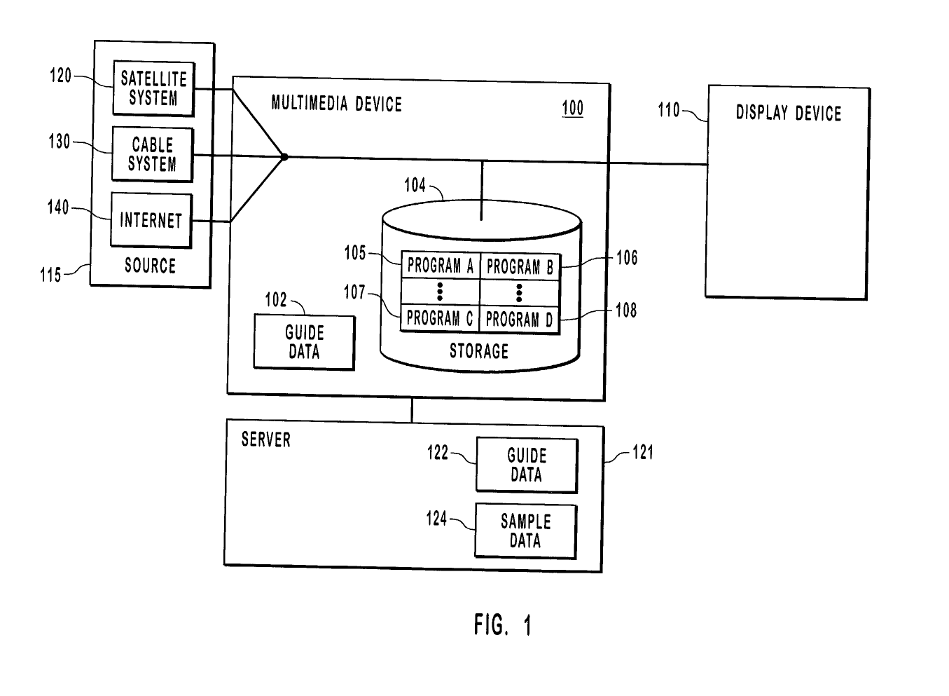

FIG. 1 is a block diagram that illustrates an exemplary system for implementing the present invention. FIG. 1 depicts a multimedia device 100 that receives programming content or broadcasts from multiple sources 115 which may include, but are not limited to, a satellite system 120, a cable system 130, and the Internet 140. The programming content from the satellite system 120 and the cable system 130 typically includes multiple video streams that correspond to various channels or programs. The programming content received or accessed over the Internet 140 can also be a video stream, but can also include other types of content that is known in the art.

Another type of programming content received over the sources 115 is guide data. The guide data 102 is stored on the multimedia device 100 and is used to inform the user of the programming content that is currently being broadcast and that will be broadcast in the future. The guide data 102 may include, but is not limited to, program titles, program descriptions, program ratings, program start times, program duration, program end times, and the like or any combination thereof. Alternatively, the guide data 102 is retrieved from a server 121, which maintains master guide data 122. The server 121 may also store sample data 124, which will be described below.

The multimedia device 100 also includes a storage 104, which may be for example a hard drive or other type of memory. The storage 104 is used by the multimedia device 100, for example, to record video streams or programs that are broadcast by the sources 115. As illustrated in FIG. 1, multiple programs may be recorded on the storage 104 of the multimedia device 100. In this example, program A 105, program B 106, program C 107, and program D 108 are stored or recorded on the storage 104 of the multimedia device 100. It is understood that the multimedia device 100 that records a program also includes those situations where the multimedia device 100 causes another box to record the program.

The programming content received from the sources 115, whether recorded or live, is displayed on the display device 110, which may be, for example, a television. Thus, a user not only has the ability to view the current programming content being broadcast by the sources 115, but the user may also view recorded programming content by selecting one of the recorded programs.

Because the sources 115 often provide hundreds of different channels or broadcasts and because the guide data 102 is often incomplete, a user is often unsure of whether a particular program has been recorded. For example, a user may instruct or program the multimedia device 100 to record all episodes of a certain program. However, that particular program may be broadcast on a variety of different channels and/or may be repeated during the day on the same channel. As a result, the user may record the same program multiple times. This is inefficient for several reasons. For instance, storage space is required to store the redundant program and a tuner is required to record the program that is already recorded.

The present invention can determine whether a current program has already been recorded. If the program is already recorded, then the current recording can be either terminated and/or discarded. This frees the storage of the multimedia device 100 for other uses or for recording other programs that are not duplicates of previously recorded programs. The user is thus assured that the programs recorded on the storage 104 are likely to be unique programs with respect to each other.

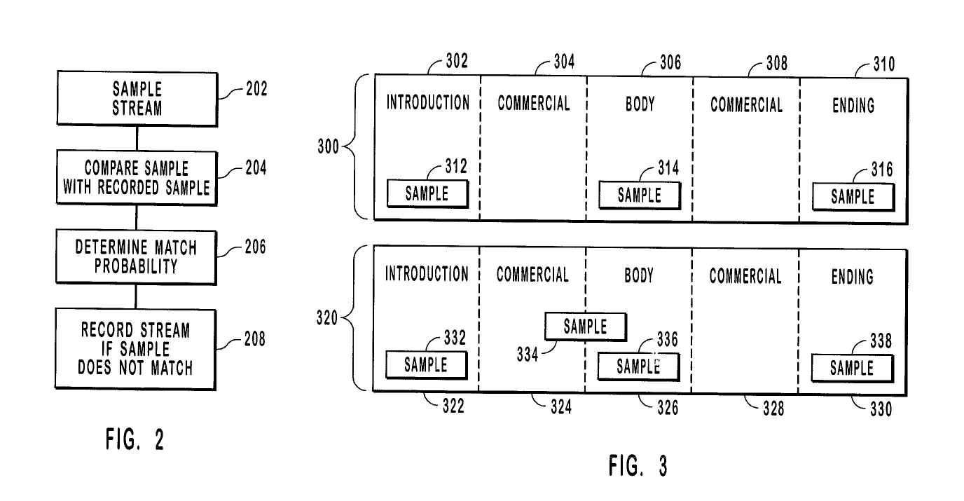

FIG. 2 is a flow diagram illustrating an exemplary method for determining whether a broadcast, program, or video stream has been previously recorded. The video stream is first sampled (202). In some instances, the video stream or program is sampled more than once at various times during the broadcast of the video stream. Then, each sample is compared (204) with samples from video streams or programs that have already been recorded. From the comparisons, the likelihood of a match is determined (206) between the video stream being recorded and the previously recorded video streams. A match between the samples indicates that the video stream or program has already been recorded. In this case, the recording is usually terminated and discarded. If a match is not found (208), between the samples, then the recording continues or the video stream is otherwise processed by the multimedia device.

The uniqueness of a video stream is determined by sampling the contents of a compact description stream that is part of the video stream. In one example, the closed caption component of the video stream is sampled. The closed caption component is useful because it is built into the video stream, is included in most broadcasts and is passed through broadcast stations, cable systems, and satellite systems unaltered. For this reason, the closed caption stream is usually identical for each broadcast and is independent of time and source. By sampling and comparing the closed caption stream, the uniqueness of the video stream can be determined.

FIG. 3 is a block diagram that is used to more fully illustrate an example of how the multimedia device determines whether to record a program. The program 300, in this example, is already recorded on the multimedia device. The program 300 typically includes an introduction 302, a body 306, and an ending 310. The commercials 304 and 308 are typically broadcast during the program 300. The samples 312, 314, and 316 represent samples of the closed captioning stream included in the program 300. The samples 312, 314, and 316 may be of another description stream including, but not limited to, MPEG I-frame fields, digital audio, and the like. Alternatively, the samples 312, 314, and 316 are stored on the server as sample data, as shown in FIG. 1, and are not maintained at the multimedia device.

Because samples can be stored remotely, a user or the multimedia device is not limited to comparing a particular sample with samples of recorded programs that already exist on the user's multimedia device. Samples can also be compared to the samples that are stored, for example, on a remote server. A user may be able, for example, to identify whether a program has already been viewed by the user even if the show is not currently recorded or stored on the multimedia device.

Samples that are remotely stored can also be used to identify programs before they are broadcast. For example, samples from shows being broadcast in a particular time zone can be stored on a server. Users in later time zones can access the samples stored on that server to determine the uniqueness of the program that has not been broadcast. In this manner, a user does not have to wait for the program to begin before determining that the program has already been viewed or is already recorded. This information can be used for other purposes as well. For example, a user that is recording each episode of a particular series may use this information to record the program even though the user may have already viewed the program.

With reference to FIG. 3, the program 320 represents a program or video stream that the multimedia device will record if it is unique or not the same as the program 300. Typically, the program 320 also has an introduction 322, a body 326, and an ending 330. Usually, commercials 324 and 328 are also broadcast during the program 320. It is understood that some programs will not have commercials and that programs may be arranged differently or have a different structure. In all cases, samples of the programs can be taken and compared with recorded samples.

As described with reference to FIG. 2, the stream of the program 320 is sampled. It is preferable to obtain more than one sample and the samples are usually taken at the same time or point of the particular program in which the recorded samples were taken. In this example, samples 332, 334, 336, and 338 have been taken from the program 320. One of the reasons for taking multiple samples is that some programs include similar or identical content. For example, many episodes of some programs always have the same introduction. Thus, it is possible that the sample 312 of the program 300 will substantially match the sample 322 because both samples are taken during the introduction of the respective programs. Alternatively, the sample 332 may include a scene that was broadcast during the previous week. In this case, the sample 332 may substantially match the sample 314, which was taken during the body of the program 306. Using these samples alone, the multimedia device may determine that the program 320 has already been recorded, when in fact, the program 320 has not been recorded. A similar situation may also arise with respect to samples taken during the ending of shows, where the same or similar credits may be broadcast. The choice of sampling points may be determined, for example, by the structure or length of the program, the characteristics of the broadcast network, or other heuristics

A particular sample may also be taken during a commercial, such as the sample 334. In this case, the sample 334 will not likely match any of the samples from the previously recorded program 300 and the multimedia device may determine that the program 320 is unique, when it is the same. For at least these reasons, it is preferable to take several samples of a program, although it is possible to determine whether a particular program is unique with respect to previously recorded programs using a single sample.

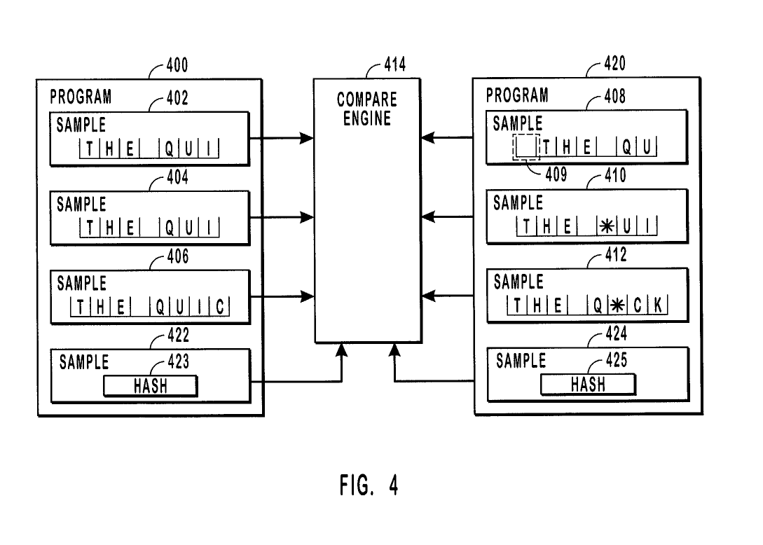

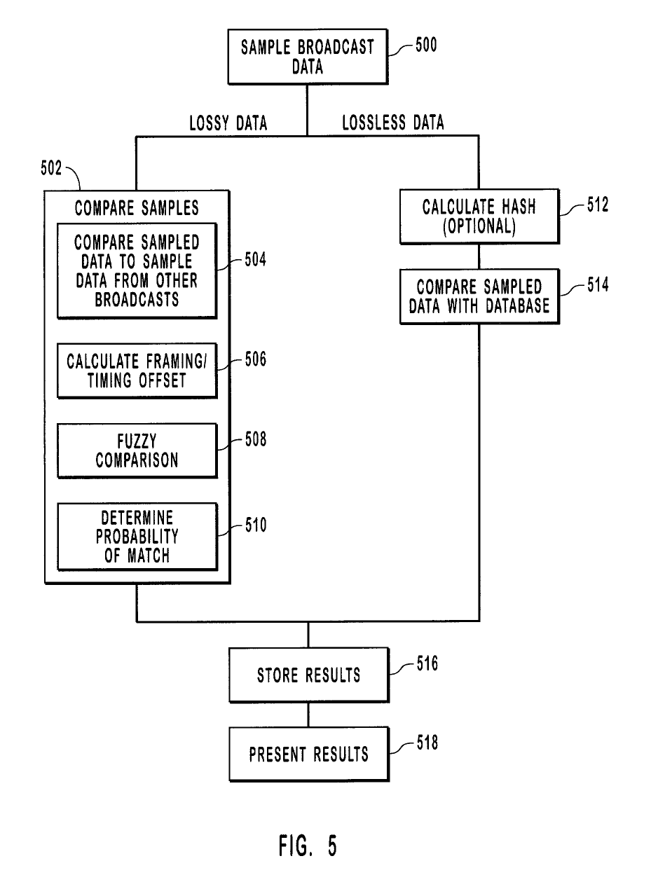

FIG. 4 is a block diagram illustrating exemplary samples of the closed caption stream, or other portion of the video stream, for comparison. In this example, samples from the program 400 are compared against samples from the program 420 using the compare engine 414. In the broadcast of some programs, the program is broadcast at a slight timing offset from the true time. The sample 408 exhibits a timing offset 409. When the sample 402 is compared against the sample 408, the timing offset of the sample 408 and of the program 420 can be determined and accounted for in the comparison between the samples 402 and 408. The program 420 is compensated to account for the timing offset to eliminate comparison errors that would otherwise occur.

In some situations, there may be small errors in the data stream. These errors are often caused, for example, by RF interference or other transient noise. For this reason, it is often necessary to perform a fuzzy comparison between the samples. The following examples illustrate situations where a fizzy comparison is useful. First, the comparison between the sample 404 and the sample 410 illustrates a scenario where there is an incorrect character. The “Q” of sample 410 is incorrect, but a fuzzy comparison of the sample 404 and the sample 410 will indicate a match in this case. Second, the comparison between the sample 406 and the sample 412 illustrates a situation where there is a missing character as well as an incorrect character. In the sample 412, the “U” is incorrect and the “I” is missing. A fuzzy comparison in these situations results in a determination that the samples match in spite of the slight differences that exist. From these comparisons, a probability can be determined that indicates whether the program being tested or sampled has already been recorded or viewed by a user. Hash and fuzzy comparisons described herein are based on known techniques.

FIG. 4 also illustrates another comparison between sample 422 and sample 424. In this instance, the sampled segments have been hashed. In other words, the samples or program segments are shortened or otherwise compressed. The hash 423 is compared against the hash 425 to assist in the determination of whether the program 420 is the same as the program 400. In this situation, compressed samples such as the hash 423 and the hash 425 typically prevent the fuzzy comparisons previously described. Thus, this type of sampling is typically used in situations where data errors and offsets are minimal such as digital broadcast sources. Alternatively, some samples may be compressed for storage purposes, but are uncompressed when compared against other samples.

In another example, a data sequence can be placed in the data or video stream that uniquely identifies the broadcast or the program. Using the data sequence, a user can determine whether the broadcast has been previously recorded by comparing the data sequence with the data sequence of previously recorded programs. The data sequence can also be used to identify other characteristics or attributes of the program. For instance, the data sequence may determine a particular ordering of various programs. When one program is the first part of a two part series, this information can be determined from the data sequence. For example, the data sequence may be the concatenation of the program title, episode identifier, and continuation code (“TITLE-EPISODE-CODE”). Alternatively, the data sequence may be a hash or other unique identifier that is generated from specific parts of a program, such as the closed captioning information.

FIG. 5 is a flow diagram that illustrates an exemplary method for testing or identifying a unique program or broadcast. Determining whether a broadcast has already been recorded/viewed or otherwise processed begins with obtaining samples of the broadcast data (500) or the video stream. As previously described, multiple samples are preferred in order to compensate for data errors, commercial interruptions, and repeated segments. If the broadcast is a lossless broadcast, the samples are compared with samples stored in a database (514). Optionally, the samples are compressed or hashed (512) before they samples are compared with other samples which are similarly compressed or hashed. The results of the comparison between the samples are stored (516) and the user is presented with the results of the comparison (518). With the results of the comparisons, other information is also stored including, but not limited to, a timestamp, channel, program listing, and the like. Typically, if the program is determined to be unique, it is recorded. Otherwise, the recording is discarded when the multimedia device determines that the program has already been recorded or viewed. After the multimedia device determines that the program has already been recorded or viewed, the multimedia device may cause this information to be reflected in the guide data. An icon may be included, for example, along with the programs that have already been viewed or recorded, for example, by the multimedia device or user.

If the broadcast is lossy, then the samples are compared (502). The comparison of the samples includes comparing the samples with samples from other broadcasts (504) that are stored on the multimedia device or that are stored remotely on a server. During the comparison of the samples (502), the framing or timing offset is determined when necessary and the samples are compensated (506) such that the framing or timing offset is not a factor. A fuzzy comparison (508) may also be performed on the samples. Finally, a probability of a match is determined. These actions of compensating the video stream for offsets and of performing fuzzy comparisons are often repeated more than once for any given sample in order to obtain a better comparison between the samples.

The results of the comparison between the samples are stored (516) and appropriate action is taken based on those results. A match between the samples results in the program not being recorded while a mismatch results in the program being recorded because the program is unique with respect to the programs with which it was compared. Finally, the user is presented with the results (518). The results can be displayed on the display device or can be retrieved by the user at a later time.

In another example, a user may desire to record a particular program, but is unable to program the multimedia device to record that program because the user does not know when the program is broadcast or because the guide data is incomplete. For instance, a user may hear an advertisement for a movie that the user wants to watch, but the user does not remember when the movie will be broadcast. The user can record this program using previously recorded samples or using samples that can be remotely accessed. For example, a user desiring to record a series program will likely have samples of a different episode of the same program. Using samples from the beginning of the show, which is likely the same for both episodes, the program can be recorded with these samples match. Alternatively, a user desiring to record a program for which no samples are locally available can download samples from a remote server such that the show can be identified even when the user does not know when the show is broadcast.

In this situation, this aspect of the present invention enables the user to record the program based on the samples. For example, many programs, as previously stated, have the same introduction every week or every time an episode of the program is broadcast. The program or video stream of a particular channel can be monitored or repeatedly sampled. These samples are then compared to a sample of the introduction of the program the user desires to record. When a matching sample is found, the multimedia device can determine that the program being broadcast is the program the user desires to record. A match between a pair of introduction samples indicates that the program is the same, even though the particular episode may be different. This can be coupled with further samplings of the program to determine if the program has already been recorded.

This type of sampling is also useful in situations where a program is delayed or interrupted. For example, some sports programming exceeds the allotted time period and a program that the user desires to record may start later than expected. Without the present invention, the user will not be able to record the program because the termination of the sports programming is unknown. By monitoring and sampling the video stream or program, the multimedia device will be able to recognize the introduction of a particular program and begin recording the program for the user. When a program is interrupted, the multimedia device will not terminate recording until samples from the ending of the programs substantially match.

Identifying a unique program can also be useful when a user desires to record a series program. In one example, an episode is already recorded and samples of that program may be used to determine if future episodes are unique with respect to the episode that is already recorded. Each week, or however often the program is broadcast, the multimedia device can record the currently broadcasting program. Samples of the current broadcast can be compared to samples of the programs that are already recorded. If a match is discovered, then the recording is terminated because that episode is already recorded. Alternatively, the program will be recorded in its entirety and any duplicates will be deleted from the multimedia device. This is useful because it is often difficult to determine the uniqueness of a particular program from the introduction and a program has already been substantially recorded in some instances, before a determination is made that the program is unique or a duplicate. In this manner, a user is able to record an entire season of a particular program without recording some of the episodes multiple times.

The present invention is not limited to video streams but can be applied to other data streams delivered from a source to a multimedia device. In particular, music that is delivered can be recorded in a similar fashion. Samples of a particular song, for example, can be retrieved from the multimedia device or a remote server and compared against samples of an incoming music stream. The current music stream may be recorded if the samples selected by the user match samples from the current music stream. In other words, a user may be able to use samples to identify which songs should be recorded even when the user does not know when the songs will be broadcast. Also, the user can use samples to refrain from recording songs that are already recorded.

The present invention extends to both methods and systems for identifying unique broadcasts. The embodiments of the present invention may comprise a special purpose or general-purpose computer including various computer hardware, as discussed in greater detail below. Special purpose computers and general purpose computers are examples of multimedia devices as used herein.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a system that includes a multimedia device that receives programming content from one or more sources, and wherein the multimedia device is able to record at least some of the programming content, a method for identifying a unique program included in the programming content with respect to other programs, the method comprising:
obtaining at least one sample of a current program included in the programming content;
comparing the at least one sample of the current program against one or more samples from the other programs; and
determining that the current program is unique if the at least one sample of the current program does not substantially match the one or more samples from the other programs.

2. A method as defined in claim 1, wherein obtaining at least one sample of a current program included in the programming content further comprises one or more of:
obtaining the at least one sample from a closed caption component of the current program;
obtaining the at least one sample from a frame field component of the current program;
obtaining the at least one sample from an audio component of the current program;
obtaining the at least one sample from a data stream of the current program; and
obtaining the at least one sample from a description stream of the current program.

3. A method as defined in claim 1, wherein comparing the at least one sample of the current program against one or more samples from the other programs further comprises one or more of:
determining a framing offset of the program; and
compensating the at least one sample for the framing offset.

4. A method as defined in claim 1, wherein comparing the at least one sample of the current program against one or more samples from the other programs further comprises one or more of:
determining a timing offset of the program; and
compensating the at least one sample for the timing offset.

5. A method as defined in claim 1, wherein comparing the at least one sample of the current program against one or more samples from the other programs further comprises performing a fuzzy comparison between the at least one sample of the current program and the one or more samples from the other programs.

6. A method as defined in claim 1, wherein comparing the at least one sample of the current program against one or more samples from the other programs further comprises determining a probability of a match between the current program and at least one of the other programs.

7. A method as defined in claim 1, further comprising recording the current program if the current program is unique.

8. A method as defined in claim 1, further comprising:
recording the current program if the current program is not unique; and
deleting duplicates of the current program that are stored on the multimedia device.

9. A method as defined in claim 1, wherein comparing the at least one sample of the current program against one or more samples from the other programs further comprises:
shortening the at least one sample to produce a shortened segment for the current program; and
comparing the hash segment against other hash segments of the other programs.

10. A method as defined in claim 9, wherein shortening the at least one sample further comprises at least one of:
hashing the at least one segment; and
compressing the at least one segment.

11. A method as defined in claim 1, wherein comparing the at least one sample of the current program against one or more samples from the other programs further comprises comparing the at least one sample of the current program against samples stored on a remote server.

12. A method as defined in claim 1, wherein comparing the at least one sample of the current program against one or more samples from the other programs further comprises creating the at least one sample on a remote server.

13. In a system that includes a multimedia device that receives programming content from one or more sources, and wherein the multimedia device is able to record programs from the programming content, a computer program product for implementing a method for identifying a unique program included in the programming content with respect to other programs, the computer program product comprising:
a computer readable medium having computer executable instructions for performing the method, the method comprising:
obtaining at least one sample of a current program included in the programming content;
comparing the at least one sample of the current program against one or more samples from the other programs; and
determining that the current program is unique if the at least one sample of the current program does not substantially match the one or more samples from the other programs.

14. A computer program product as defined in claim 13, wherein obtaining at least one sample of a current program included in the programming content further comprises one or more of:
obtaining the at least one sample from a closed caption component of the current program;
obtaining the at least one sample from a frame field component of the current program;
obtaining the at lest one sample from a data stream of the current program; and
obtaining the at least one sample from a description stream of the current program.

15. A computer program product as defined in claim 13, wherein comparing the at least one sample of the current program against one or more samples from the other programs further comprises one or more of:
determining a framing offset of the program; and
compensating the at least one sample for the framing offset.

16. A computer program product as defined in claim 13, wherein comparing the at least one sample of the current program against one or more samples from the other programs further comprises one or more of:
determining a timing offset of the program; and
compensating the at least one sample for the timing offset.

17. A computer program product as defined in claim 13, wherein comparing the at least one sample of the current program against one or more samples from the other programs further comprises performing a fuzzy comparison between the at least one sample of the current program and the one or more samples from the other programs.

18. A computer program product as defined in claim 13, wherein comparing the at least one sample of the current program against one or more samples from the other programs further comprises determining a probability of a match between the current program and at least one of the other programs.

19. A computer program product as defined in claim 13, further comprising recording the current program if the current program is unique.

20. A computer program product as defined in claim 13, further comprising:
recording the program if the current program is not unique; and
deleting duplicates of the current program.

21. A computer program product as defined in claim 13, wherein comparing the at least one sample of the current program against one or more samples from the other programs further comprises:
shortening the at least one sample to produce a shortened segment for the current program; and
comparing the hash segment against other hash segments of the other programs.

22. A computer program product as defined in claim 21, wherein shortening the at least one sample further comprises one of:
hashing the at least one sample; and
compressing the at least one sample.

23. A computer program product as defined in claim 13, wherein comparing the at least one sample of the current program against one or more samples from the other programs further comprises comparing the at least one sample of the current program against samples stored on a remote server.

24. In a system that includes a multimedia device that receives broadcasts from one or more sources, and wherein the multimedia device is able to record programs included in the broadcasts, a method for recording a current program included in the programming content such that the current program is unique with respect to other programs that are recorded on the multimedia device or that are stored remotely from the multimedia device, the method comprising:
obtaining at least one sample from a descriptive stream of a current program included in the broadcasts;
comparing the at least one sample of the current program against one or more samples from the other programs, wherein the one or more samples of the other programs are taken from the descriptive streams of the other programs; and
recording the current program if the at least one sample of the current program does not substantially match the one or more samples from the other programs.

25. A method as defined in claim 24, wherein obtaining at least one sample from a descriptive stream of a current program included in the broadcasts further comprises one or more of:
obtaining the at least one sample from a closed caption component of the current program; and
obtaining the at least one sample from a frame field component of the current program;
obtaining the at least one sample from a data stream of the current program; and
obtaining the at least one sample from an audio stream of the current program.

26. A method as defined in claim 24, wherein comparing the at least one sample of the current program against one or more samples from the other programs further comprises one or more of:
determining a framing offset of the program;
compensating the at least one sample for the framing offset;
determining a timing offset of the program; and
compensating the at least one sample for the timing offset.

27. A method as defined in claim 24, wherein comparing the at least one sample of the current program against one or more samples from the other programs further comprises performing a fuzzy comparison between the at least one sample of the current program and the one or more samples from the other programs.

28. A method as defined in claim 24, wherein comparing the at least one sample of the current program against one or more samples from the other programs further comprises determining a probability of a match between the current program and at least one of the other programs.

29. A method as defined in claim 24, wherein comparing the at least one sample of the current program against one or more samples from the other programs further comprises:
compressing the at least one sample to produce a shortened segment for the current program; and
comparing the hash segment against other hash segments of the other programs.

30. A method as defined in claim 24, wherein comparing the at least one sample of the current program against one or more samples from the other programs further comprises comparing the at least one sample of the current program against samples stored on a remote server.

31. In a system that includes a multimedia device that receives broadcasts from one or more sources, and wherein the multimedia device is able to record programs included in the broadcasts, a computer program product for implementing a method for recording a current program included in the programming content such that the current program is unique with respect to other programs that are recorded on the multimedia device or that are stored remotely from the multimedia device, the computer program product comprising:
a computer readable medium having computer executable instructions for performing the method, the method comprising:
obtaining at least one sample from a descriptive stream of a current program included in the broadcasts;
comparing the at least one sample of the current program against one or more samples from the other programs, wherein the one or more samples of the other programs are taken from the descriptive streams of the other programs; and
recording the current program if the at least one sample of the current program does not substantially match the one or more samples from the other programs.

32. A computer program product as defined in claim 31, wherein obtaining at least one sample from a descriptive stream of a current program included in the broadcasts further comprises one or more of:
obtaining the at least one sample from a closed caption component of the current program; and
obtaining the at least one sample from a frame field component of the current program;
obtaining the at least one sample from a data stream of the current program; and
obtaining the at least one sample from an audio stream of the current program.

33. A computer program product as defined in claim 31, wherein comparing the at least one sample of the current program against one or more samples from the other programs further comprises one or more of:
determining a framing offset of the program;
compensating the at least one sample for the framing offset;
determining a timing offset of the program; and
compensating the at least one sample for the timing offset.

34. A computer program product as defined in claim 31, wherein comparing the at least one sample of the current program against one or more samples from the other programs further comprises performing a fuzzy comparison between the at least one sample of the current program and the one or more samples from the other programs.

35. A computer program product as defined in claim 31, wherein comparing the at least one sample of the current program against one or more samples from the other programs further comprises determining a probability of a match between the current program and at least one of the other programs.

36. A computer program product as defined in claim 31, wherein comparing the at least one sample of the current program against one or more samples from the other programs further comprises:
compressing the at least one sample to produce a shortened segment for the current program; and
comparing the hash segment against other hash segments of the other programs.

37. A computer program product as defined in claim 31, wherein comparing the at least one sample of the current program against one or more samples from the other programs further comprises comparing the at least one sample of the current program against samples stored on a remote server.

38. In a system that includes a multimedia device that receives broadcasts from one or more sources, and wherein the multimedia device is able to record programs included in the broadcasts, a method for recording a program included in the programming content when a start time of the program is unknown, the method comprising:
obtaining at least one sample from a video stream of the broadcasts, wherein the multimedia device does not know if the video stream is the program;
comparing each sample of the video stream against an introduction sample from an introduction portion of a recorded program, wherein an introduction portion of the program is similar to an introduction portion of the recorded program;
when a sample of the video stream substantially matches the introduction sample of the recorded program, determining that the video stream is the program; and
recording the program.

39. A method as defined in claim 38, wherein comparing each sample of the video stream against an introduction sample from an introduction portion of a recorded program further comprises:
obtaining the at least one sample from a closed caption component of the current program; and
obtaining the at least one sample from a frame field component of the current program;
obtaining the at least one sample from a data stream of the current program; and
obtaining the at least one sample from an audio stream of the current program.

40. A method as defined in claim 38, wherein comparing each sample of the video stream against an introduction sample from an introduction portion of a recorded program further comprises performing a fuzzy comparison between the at least one sample of the current program and the one or more samples from the other programs.

41. A method as defined in claim 38, further comprising terminating the recording when an end sample of the recorded program substantially matches another sample taken from the program being recorded.

42. method as defined in claim 38, wherein comparing each sample of the video stream against an introduction sample from an introduction portion of a recorded program, wherein an introduction portion of the program is similar to an introduction portion of the recorded program further comprises one of: retrieving the introduction sample from the multimedia device; and retrieving the introduction from a remote server.

43. A computer program product having computer executable instructions for performing the steps of claim 38.

44. In a system that includes a multimedia device that receives broadcasts from one or more sources, and wherein the multimedia device is able to record programs included in the broadcasts, a method for recording each episode of a series program, the method comprising:
recording an episode of a series program;
comparing samples of the episode with samples of previously recorded episodes of the series program;
comparing the samples of the episode with samples of each previously recorded episode of the series program; and
ensuring that only one recording of each episode is stored on the multimedia device using the comparison.

45. A method as defined in claim 44, wherein ensuring that only one recording of the episode is stored on the multimedia device further comprises:
terminating the current recording of the episode if the samples substantially match samples of a previously recorded episode.

46. A method as defined in claim 44, wherein ensuring that only one recording of the episode is stored on the multimedia device further comprises:
recording the current episode; and
deleting duplicates of the current episode.

47. In a system that includes a multimedia device that receives broadcasts from one or more sources, and wherein the multimedia device is able to record programs included in the broadcasts, a method for recording a program included in the programming content when an end time of the program is unknown, the method comprising:
obtaining at least one sample of the program;
comparing each sample of the program against an end sample from an end portion of a recorded program, wherein the end portion of the program is similar to the end portion of the recorded program; and
when a sample of the video stream substantially matches the end sample of the recorded program, ending the recording of the program.

48. In a system that receives programming content from one or more sources and wherein the system is able to record at least some of the programming content, a method for recording a program, the method comprising:
obtaining at least one sample of the closed captioning data from the program;
comparing the at least one sample of the closed captioning data against one or more samples of closed captioning data from other programs; and
recording the program if the at least one sample of the closed captioning data from the program does not substantially match the one or more samples of closed captioning data from the other programs.

49. A method as defined in claim 48, further comprising retrieving the one or more samples of closed captioning data from other programs from one of a local source and a remote server.
